(19) United States
(12) Patent Application Publication
(10) Pub. No.: US 2024/0320542 A1
(43) Pub. Date: Sep. 26, 2024

(54) MACHINE LEARNING INTELLIGENT DISPATCHING SYSTEM AND INTELLIGENT DISPATCHING METHOD THROUGH MACHINE LEARNING

(71) Applicant: United Semiconductor (Xiamen) Co., Ltd., Xiamen (CN)

(72) Inventors: Guan Yao Ying, Shamen City (CN); You Sheng Yin, Shamen City (CN); Wen Yi Tan, Xiamen (CN)

(73) Assignee: United Semiconductor (Xiamen) Co., Ltd., Xiamen (CN)

(21) Appl. No.: 18/142,591

(22) Filed: May 3, 2023

(30) Foreign Application Priority Data
Mar. 23, 2023 (CN) 202310289849.4

(51) Int. Cl. G06N 20/00

(52) U.S. Cl. CPC G06N 20/00

(57) ABSTRACT

A machine learning intelligent dispatching system, including a history information module storing various history data, a basic information module storing various basic data, an algorithm module working out predicted runtimes and switching times of recipe groups based on the history data and basic data through machining learning, a robot module working out an optimized schedule result based on the history data and basic data and the predicted times, and a dispatching module dispatching lots according to the optimized schedule result to obtain an actual production result, and the actual production result is fed back to the robot module as a basis for the machine learning.

### BACKGROUND OF THE INVENTION

### 1. Field of the Invention

The present invention relates generally to a dispatching system, and more specifically, to a machine learning intelligent dispatching system and intelligent dispatching method through machine learning

### 2. Description of the Prior Art

Wafer manufacture is one of most rapidly developed manufacturing industries in the world. The production characteristics of wafer Fab is quite different from conventional flow-oriented or job-shop production mode, including the production mode like high mix low volume (HMLV), recirculation job, lot splitting and batch job, making the production schedule of wafer Fab very complicated. Accordingly, establishing dispatching rules is practically the most universal method to solve the problem of in-situ process monitoring in wafer Fab.

Nevertheless, dispatching rules used in current wafer Fab are mostly common priority selection based, or selecting the lots to be processed based on idle tools or based on human experience of inline operator, which is hard to take into account the substantial benefits of entire Fab. Thus, it is urgent to find a dispatching rule that is easy to implement and can take into account the performance of entire Fab. Furthermore, in response to the development of Industry 4.0, how to establish an intelligent Fab with adaptability, resource efficiency and human factors engineering through artificial intelligent technology becomes the principle of development in wafer manufacturing industry, in hope of achieving the goals of intelligent manufacture, improving production capacity and reducing cycle time.

### SUMMARY OF THE INVENTION

In the light of the aforementioned circumstances, the present invention hereby provides an intelligent dispatching system and method, with feature of simulating the learning behavior of human through machine learning, and learning the modes of human dispatching intervention based on relevant information through different algorithms to work out an optimized result. Multiple comparison actions are performed and cycled to reach an optimized result most matched with the actual result, and intelligent dispatching is realized according to the result cooperating with the real-time dispatching system in the Fab.

One objective of the present invention is to provide a machine learning intelligent dispatching system, with structure including a history information module storing various history data relevant to tools, recipe groups and lots, a basic information module storing various basic data relevant to the tools, the recipe groups and the lots, an algorithm module working out predicted runtimes and predicted switching times of specific recipe groups when specific lots are processed in specific tools based on the history data and the basic data through machine learning, a robot module working out an optimized schedule result based on the history data, the basic data, the predicted runtimes and the predicted switching times of specific recipe groups, and a dispatching module dispatching the lots according to the optimized schedule result to obtain an actual production result and feed the actual production result back to the robot module.

Another objective of the present invention is to provide an intelligent dispatching method through machine learning, including steps of acquiring various history data and basic data relevant to tools, recipe groups and lots from database, working out predicted runtimes and predicted switching times of specific recipe groups when specific lots are processed in specific tools based on the history data and the basic data through different machining learning algorithms, working out an optimized schedule result based on the history data, the basic data, the predicted runtimes and the predicted switching times of specific recipe groups, dispatching lots according to the optimized schedule result to obtain an actual production result, and comparing the actual production result and the optimized schedule result and feeding back a comparison result as a basis for the machine learning algorithms.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic sheet of production schedule of multiple tools in semiconductor fabrication plant (Fab);

FIG. 2 is a system block diagram of an intelligent dispatching system based on machine learning in the preferred embodiment of present invention;

FIG. 3 is a flowchart of a machine learning intelligent dispatching system in the preferred embodiment of present invention;

FIG. 4 is a schematic diagram of a decision tree algorithm model;

FIG. 5 is a schematic diagram of a random forest algorithm model;

FIG. 6 is a schematic diagram of an artificial neural network algorithm model; and

FIG. 7 is a schematic diagram of a Bayesian network algorithm model.

Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

Reference will now be made in detail to exemplary embodiments of the invention, which are illustrated in the accompanying drawings in order to understand and implement the present disclosure and to realize the technical effect. It can be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

Preferably, one or more of such embodiments of the present invention are embodied in a computer implemented program or control system. The computer for executing this kind of program or control system may be a general purpose computer architecture, wherein user may enter commands for executing the computer-implemented methods of the present invention through user interfaces like displayer, keyboard or mouse, or these methods may be executed automatically through automatic control system. The processor in the computer may access, calculate and process the computer readable code and data from the memory of computer. High capacity storage device like disk drive may provide program code or data relevant to the computer-implemented methods of the present invention and load them into the memory. Input/output device may provide connectivity to various equipment, ex. networks, modems, printers or process tools.

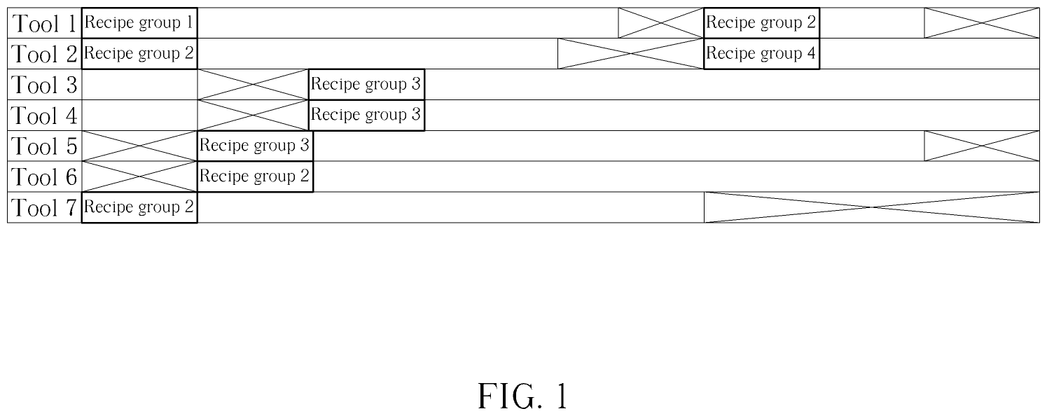

Please refer first to FIG. 1, which is a schematic sheet of production schedule of multiple tools in semiconductor fabrication plant (Fab). In semiconductor manufacture, bare wafers will be subject to hundreds of processes in various tools and processed into IC wafers with semiconductor devices and circuit structures formed thereon at last. During the process, tool will perform semiconductor process to the wafers according to predetermined recipe groups. The recipe group decides the actions and environments to be performed in the process, which may include multiple steps, temperature in the steps, voltage, duration, and the type, concentration and dose of introduced substances, etc. One tool may be preset with multiple recipe groups for executing different processes.

As shown in FIG. 1, take photolithography process as an example. Tools 1-7 are mask aligner and are preset with recipe groups 1-4. The length of cell on the right of the recipe group represents required runtime to execute the corresponding recipe group in the tool. The length of crossed out cell on the left of recipe group represents required switching time (may also be referred as downtime) from previous finished recipe group to next recipe group. Under normal circumstances, different recipe groups are provided with different runtimes and required switching times before being executed. For example, mask aligner needs time to change heat/cold plate and photoresist material when switching recipe groups, and the required switching times for various recipe groups are unequal. Under this circumstance, lots should be scheduled in production line based on the recipe groups to be executed for the following lots in order to ensure maximum output for every tool. Besides, there may be other causes that may lead to the discrepancy of switching times and difficulty for lot scheduling, for example, corresponding tool constraints in every tool due to tool condition, regular or emergency tool preventive maintenance (PM), special product and/or process like big die product, etc., and reticle SMIF time and whether the reticle is qualified should also be concerned in the same time. These factors may inevitably cause downtime of certain lots in actual implementation due to scheduling problem, thereby increasing overall cycle time of the product.

In order to solve the aforementioned scheduling problem, the present invention hereby provides an intelligent dispatching method, with a view to improve lot scheduling through artificial intelligence and machine learning, and to replace conventional dispatching method based on priority or human experience, therefore the production capacity and efficiency may be improved.

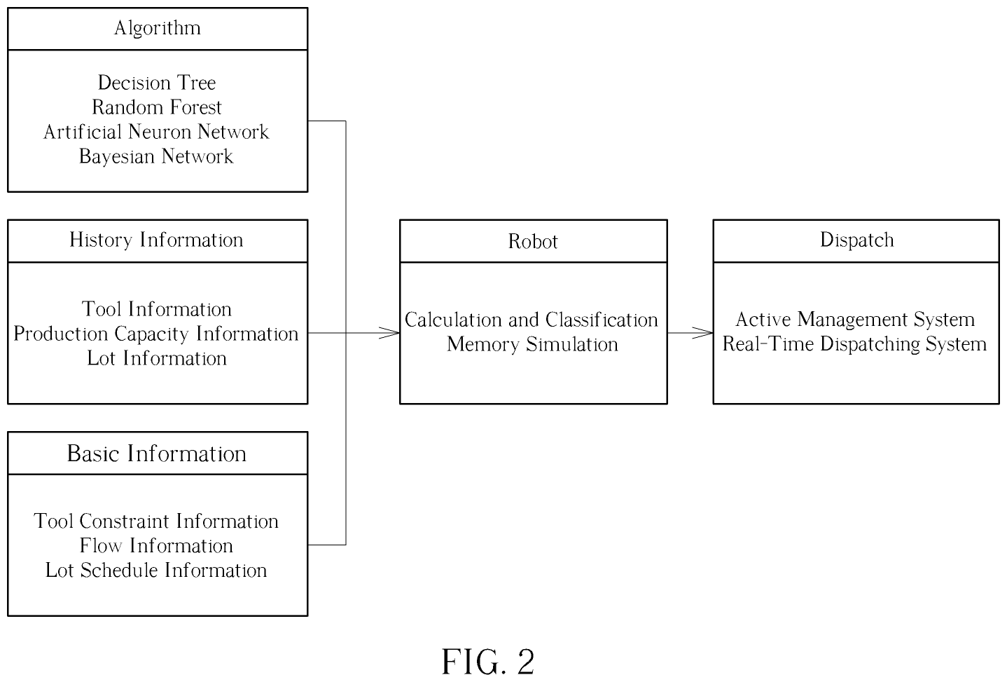

Please refer to FIG. 2, which is a system block diagram of a machine learning intelligent dispatching system in the preferred embodiment of present invention. The dispatching system of present invention generally includes modules of algorithm, history information, basis information, robot and dispatching, etc, wherein the function of algorithm module is to mine, analyze and count the data like runtimes and switching times for data-labeled recipe groups in actual situation through machine learning patterns like decision tree, random forest, artificial neural network and/or Bayesian networks, so as to work out runtimes and switching times for executing specific recipe groups in specific tools.

For example, when a new product is ready to be manufactured in production line, the product is predetermined to be processed using several recipe groups (PPID) in the aforementioned mask aligners. The systems in this example will provide approaches of statistic, analysis, knowledge-discovery in databases (KDD) through random forest algorithm, to find models and patterns from big history data, monitor data and/or basis data in the way of machine learning. During the data retrieving, analyzing and processing, algorithm module may self-determine whether to process the history data and basic data with functions like average, median or weighted treatment, so as to work out predicted runtimes and predicted switching times of specific recipe groups when the product is processed in specific tools.

Refer still to FIG. 2. The intelligent dispatching system of present invention may also be provided with a history information module and a basis information module. The history information module stores various tool information, production capacity information and lot information, but not limited thereto. Take the aforementioned mask aligner as an example, the tool information may include data like the lots being processed by these tools in past few years, the number of preventive maintenance being performed, the recipe groups and executing times and other relevant details. Production capacity information may include the number of lots being process in the mask aligner in the past, attainable maximum output and relevant details. Lot information may include the number of various lots being processed in the past, required recipe groups to be executed and relevant details. In other aspect, basic information module stores constraints of various tools, flow information, lot schedule information and relevant details, but not limited thereto. Take the aforementioned mask aligner as an example, the tool constraint information may include the prohibited types of lots or recipe groups for these tools. Flow information may include the recipe groups to be executed when processing corresponding lots in these tools, the tools where certain types of lots to be processed, and specific process steps to be performed for various recipe groups, etc. Lot schedule information may include predetermined schedule for those tools or lots.

Refer still to FIG. 2. The intelligent dispatching system of present invention is provided with a robot module, which may be a central control server and the memory device therein, to coordinate and calculate the data retrieved from the aforementioned modules. The robot module would perform actions like counting, classifying, sample data labeling and memory simulation and work out an optimized schedule result at last. The labeled sample data may be provided to the aforementioned algorithm module for machine learning. The sample data may include the target and result to be predicted and various variables used for predicting the target result through pattern recognition, in order to improve the accuracy rate or reliability of the algorithms. The memory simulation may include static memory like parametric model (i.e. model parameter is memory), non-parametric model (i.e. sample is memory), support vector machine (SVM, i.e. support vector is memory) or neural network model (i.e. weights in network connectivity is memory), etc., or dynamic memory like latent vector in recurrent neural networks (RNNs) and attention mechanism, but not limited thereto.

Refer still to FIG. 2. The intelligent dispatching system of present invention is further provided with a dispatching module, which may receive the optimized schedule result worked out from the aforementioned robot module to execute final dispatching action. The dispatching module may include automatic dispatching system and real-time dispatching (RTD) system, wherein the automatic dispatching system may retrieve the final dispatching lot list and record the lot information in the aforementioned database, while the real-time dispatching system may feed the dispatching result back to the robot module in real time for comparing the aforementioned predicted schedule time and actual schedule time in actual production, in order to correct the algorithms and make the schedule result more efficient and more suitable for target product.

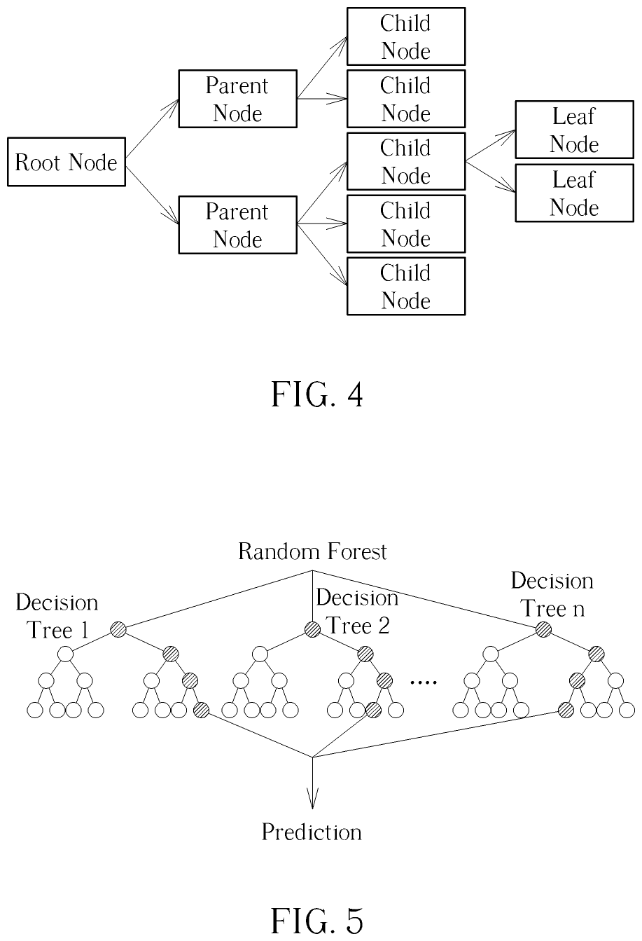

Please refer to FIG. 4. An algorithm model of decision tree will now be described. The algorithm of decision tree and its variations are to divide the input space into different sections. Every section has its individual parameters, including random event result, resource cost and utility. Samples are first classified into different subsets, and are further divided and recurred until every subset has the same class of samples. For example, the test starts from root nodes and proceeds sequentially to parent nodes, child nodes and leaf nodes, and predicted classification may be therefore obtained. The feature of this algorithm model is simple structure and high efficiency for data processing. In the embodiment of present invention, decision tree may also be used in the mining of history data and basis data relevant to tools, recipe groups and lots and may classify the object of corresponding class based on attributes through its branches. Every decision tree can test data through dividing the source database, with progress like recursion to trim the tree structure for removing unnecessary and unusable data.

Please refer to FIG. 5. An algorithm model of random forest will now be described. Random forest is generally a classifier consisted of multiple aforementioned decision threes, for example the decision tree 1 to decision tree n in the figure, and the class of its output is determined by the mode of output of individual threes. Generally, the decision tree structure that are grown very deep tends to highly irregular patterns, i.e. their training sets are overfitted, having low bias but very high variance in machine learning and training. Random forest provides a way of averaging multiple deep decision trees to reduce the variance. The feature of this method is to produce a simulator with high accuracy with respect to various target data, and multiple input parameters can be processed at the same time to evaluate and balance the error and variation in the calculation, which is quite suitable for the data mining purpose for tools and recipe groups with various process parameters and monitor parameters in Fab.

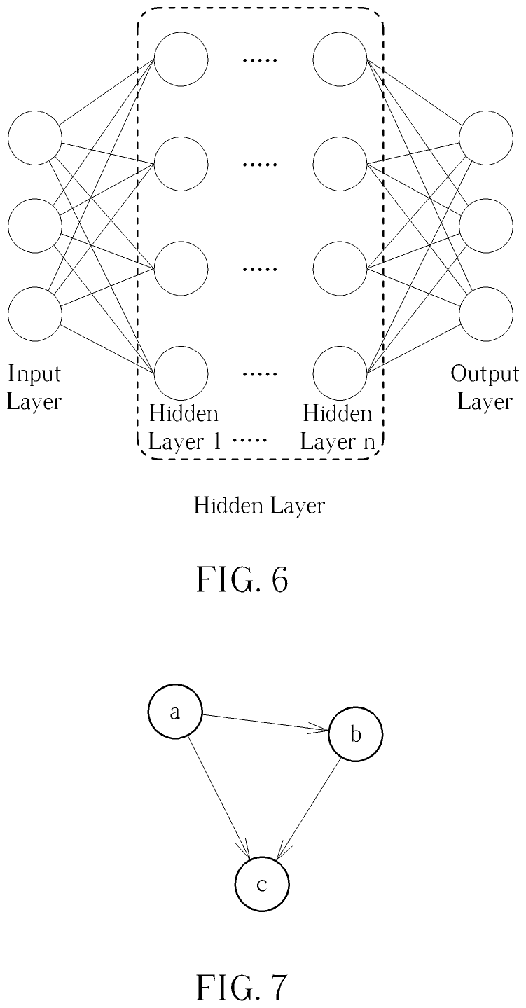

Please refer to FIG. 6. An algorithm model of artificial neural network will now be described. Artificial neural network is a nonlinear, adaptive information processing system composed of massive interconnecting process units, wherein its feedforward neural network may be generally divided into an input layer, hidden layer 1 to hidden layer n and an output layer as shown in the figure. The input layer is used to receive massive nonlinear input information, ex. history data and basis data relevant to tools, recipe groups and lots. The hidden layer is a layer composed of multiple neurons and links between the input layer and the output layer. The more the number of neuron networks, the more the nonlinearity of the neuron networks. The output layer outputs the result of information being transmitted, analyzed and balanced in the neuron networks. Artificial neuron network attempts to process the information in a fashion analog to the process and memory of neuron networks in human brain, which is provided with the intrinsic property like nonlinearity, non-limitation, non-normality and non-convexity, which may increase fault tolerance and storage capacity in data mining and provide functions like self-regulated learning and systematically evolve equilibrium state of diversity.

Please refer to FIG. 7. An algorithm model of Bayesian network model will now be described. The learning approach of Bayesian model is to use prior distribution of parameters (the distribution derived from other parameters) and posterior distribution derived from Sample information (the conditional distribution of unknown parameter, which is opposite to the prior distribution under known parameters) to work out the overall distribution directly. Its theory use probability to represent all forms of uncertainty and embody the progress of learning and reasoning through probability rules. For example, take the simplest Bayesian network in the figure for an example:

P(a,b,c)=P(c|a,b)P(b|a)P(a)

The node in the figure represents random variable, which may be observable variable or latent variable, unknown variable, ex. random variable a, random variable b and random variable c. The arrow connecting two nodes represents the two random variables having causal relationship or being non-conditional independent. On the other hand, the two nodes are conditional independent if they are not connected with each other by any arrow, and the two nodes connecting together by an one-way arrow represents one of the nodes is parent and the other is descendant or children, and these two nodes will produce a conditional probability. Take the formula above as an example, random variable a is conditional independent, P (a) represents the probability of random variable a. Random variable b depends on random variables a and c, and P(b|a) represents the probability of random variable a. Random variable c depends on random variables a and b, and P(c|a, b) represents the probability of random variable c.

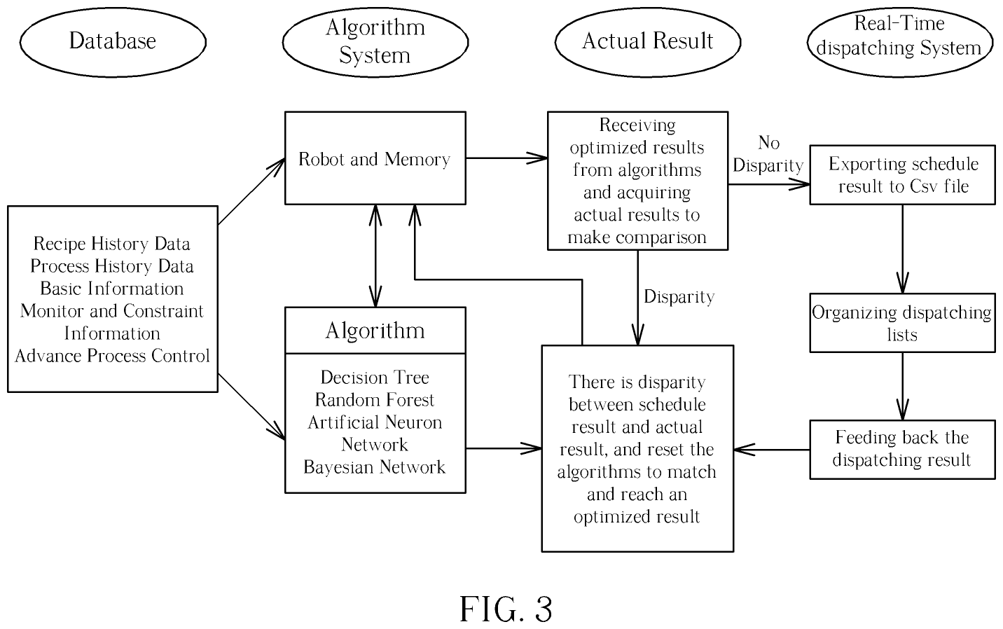

Please refer to FIG. 3. After the aforementioned basic features of machine learning algorithm are described, the flow of a machine learning intelligent dispatching method according to the preferred embodiment of present invention will now be descried. The flow of intelligent dispatch of present invention generally includes four stages, which are stages of database, algorithm system, actual result and real-time dispatch sequentially. First, in the database stage, database like the aforementioned history information module and basic information module will prepare various big data required in the intelligent dispatching method of present invention, ex. history data of recipes, history data of processes, basic information, monitor information and tool constraint information and various relevant information stored in advance process control (APC) system, for the algorithm system to retrieve later and perform machine learning and target calculation.

Refer still to FIG. 3. The algorithm module and robot module (including its memory) in algorithm system may retrieve various data stored in the aforementioned database to perform analysis and calculation, wherein the algorithm module may perform machine learning through the algorithm models like decision tree, random forest, artificial neuron network and Bayesian network, etc., to mine and analyze the aforementioned big data and count the data like runtimes and switching times of data-labeled recipe groups in actual circumstance, so as to work out a predicted runtime and switching time for specific recipe groups executed in specific tools. In other aspect, the robot module may coordinate and calculate the data retrieved from database and the predicted time from the algorithm module to work out an optimized schedule result as the schedule of multiple tools shown in FIG. 1, including the lots to be processed in individual tools, the sequence of recipe groups to be executed and corresponding predicted optimized runtime. At the same time, the robot module may perform actions like counting, classifying, data labeling and memory simulation for these data, and feed them together with the comparison result back to the algorithm module later, in order to exclude or adopt specific algorithms or patterns.

Refer still to FIG. 3. In stage of actual result, the optimized schedule result worked out by the algorithm system is executed in production lines and tools, so as to obtain an actual production result corresponding to the optimized schedule result, ex. the runtime of this optimized schedule in actual implementation. The actual runtime will be compared with the runtime predicted in the optimized schedule result, for example through regression analysis. In this comparison, system may self-regulate the algorithms, ex. embedded network algorithms like nearest neighbors algorithm, logistic regression algorithm, gradient boosting algorithm, decision tree algorithm for calculation and classification, and self-regulate the variation factors in information cross-validation like outlier, dependent variable, independent variable and variance, to clean and filter the aforementioned data in use. If the time difference in comparison result exceeds a set value, for example plus or minus 10 minutes, the system would determine there is a disparity between the optimized schedule result and the actual production result. This difference result would be feed back to the memory in robot module and algorithm module for excluding specific algorithms or models. For example, if the aforementioned data analysis and machine learning adopt regression analysis model, Bayesian model and linear model respectively to work out different optimized schedule results. According to the feedback comparison result, the regression analysis model with least comparison difference may be retained and other linear models may be excluded, so as to redo the actions of cleaning and filtering the data in use, cycle the aforementioned machine learning steps, work out new optimized schedule results and continue the follow-up actual production.

Through the aforementioned cycle actions of multiple comparisons and machine learning, an optimized schedule result may be reached with a parameter difference smaller than the set value in comparison to the actual implementation result, for example plus or minus 10 minutes, and the system will determine this optimized schedule result as no disparity in comparison to the actual production result. The flow will then proceed to the stage of real-time dispatching system, with steps including exporting the optimized schedule result to a Csv file, and the dispatching system would organize the dispatching lists and execute dispatching actions according to the Csv file. The dispatching action will execute the production sequence according to the optimized schedule result to obtain an actual production result. The actual production result is fed back to the robot module to be compared with corresponding optimized schedule result. The aforementioned machine learning steps will be cycled until an optimized schedule result most matched to the actual production result is reached.

According to the aforementioned system and implementing method provided in the preferred embodiment of present invention, the approach of counting, analyzing and knowledge discovery in database is made through machine learning to find models and patterns in big history data, monitor data and/or basis data to work out an optimized target result. The comparisons between the optimized target result and actual result are cycled to reach the optimized schedule result most matched to the actual result. The reached dispatching result may realize the intelligent dispatching models that lots select the process tools. In comparison to conventional dispatching approach that idle tool select the lots to be processed based on priority or human experience patterns, the system and method of present invention may significantly improve the production efficiency and capacity of the dispatching.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A machine learning intelligent dispatching system, comprising:
a history information module, storing various history data relevant to tools, recipe groups and lots;
a basic information module, storing various basic data relevant to said tools, said recipe groups and said lots;
an algorithm module, working out predicted runtimes and predicted switching times of specific said recipe groups when specific said lots are processed in specific said tools based on said history data and said basic data through machine learning;
a robot module, working out an optimized schedule result based on said history data, said basic data, said predicted runtimes and said predicted switching times of specific said recipe groups; and
a dispatching module, dispatching said lots according to said optimized schedule result to obtain an actual production result and feed said actual production result back to said robot module.

2. The machine learning intelligent dispatching system of claim 1, wherein said robot module compares said actual production result and said optimized schedule result and feeds a comparison result back to said algorithm module as a basis for said machine learning.

3. The machine learning intelligent dispatching system of claim 2, wherein said robot module performs data labeling and memory simulation to said history data and said basic data based on said comparison result, and said algorithm module uses information from fed back said data labeling and said memory simulation as a basis for said machine learning.

4. The machine learning intelligent dispatching system of claim 1, wherein algorithm models adopted in said machine learning comprises decision tree, random forest, artificial neural network or Bayesian network.

5. The machine learning intelligent dispatching system of claim 1, wherein said history data comprises tool information, production capacity information and lot information.

6. The machine learning intelligent dispatching system of claim 1, wherein said basic information comprises tool constraint information, flow information and lot schedule information.

7. The machine learning intelligent dispatching system of claim 1, wherein said dispatching module comprises active management system and real-time dispatching system, and said active management system executes actions of dispatching said lots and said real-time dispatching system feeds said actual production result back to said robot module in real time.

8. The machine learning intelligent dispatching system of claim 1, wherein said optimized schedule result comprises predicted optimized runtimes of multiple said lots processed in multiple said tools using multiple said recipe groups, and said actual production result comprises actual runtime of said lots dispatched according to said optimized schedule result.

9. An intelligent dispatching method through machine learning, comprising:
acquiring various history data and basic data relevant to tools, recipe groups and lots from database;
working out predicted runtimes and predicted switching times of specific said recipe groups when specific said lots are processed in specific said tools based on said history data and said basic data through different machining learning algorithms;
working out an optimized schedule result based on said history data, said basic data, said predicted runtimes and said predicted switching times of specific said recipe groups;
dispatching said lots according to said optimized schedule result to obtain an actual production result; and
comparing said actual production result and said optimized schedule result and feeding back a comparison result as a basis for said machine learning algorithms.

10. An intelligent dispatching method through machine learning of claim 9, wherein said optimized schedule result comprises predicted optimized runtimes of multiple said lots processed in multiple said tools using multiple said recipe groups, and said actual production result comprises actual runtime of said lots dispatched according to said optimized schedule result.

11. An intelligent dispatching method through machine learning of claim 10, wherein comparing said actual production result and said optimized schedule result comprises working out a difference between said predict optimized runtime and said actual runtime, and if said difference exceeds a set value, determining there is a disparity between said optimized schedule result and said actual production result, and if said difference is smaller than said set value, determining there is no disparity between said optimized schedule result and said actual production result.

12. An intelligent dispatching method through machine learning of claim 11, wherein when it is determined that there is a disparity between said optimized schedule result and said actual production result, feedback said comparison result as a basis for said machine learning algorithms.

13. An intelligent dispatching method through machine learning of claim 9, further comprising performing data labeling and memory simulation to said history data and said basic data based on said comparison result, and information from fed back said data labeling and said memory simulation are used as a basis for said machine learning algorithms.

14. An intelligent dispatching method through machine learning of claim 9, further comprising using or excluding specific said machine learning algorithms based on said comparison result.

15. An intelligent dispatching method through machine learning of claim 9, wherein said machine learning algorithms comprise decision tree, random forest, artificial neural network or Bayesian network.

16. An intelligent dispatching method through machine learning of claim 9, wherein acquiring said history data and said basic data comprises said machine learning algorithm decides whether to process said history data and said basic data with average, median or weighted treatment.

17. An intelligent dispatching method through machine learning of claim 9, wherein comparing said actual production result and said optimized schedule result comprises auto-regulating algorithms and variation factors in information cross-validation based on said recipe groups or products.
